(19) United States
(12) Patent Application Publication
(10) Pub. No.: US 2013/0322096 A1
(43) Pub. Date: Dec. 5, 2013

(54) LED LIGHTING APPARATUS

(71) Applicants: FOXCONN TECHNOLOGY CO., LTD., New Taipei (TW); CHAMP TECH OPTICAL (FOSHAN) CORPORATION, Foshan (CN)

(72) Inventors: YOU-XUE LIU, Foshan (CN); QIAN-JIN CAI, Foshan (CN); SHIH-HSUN WUNG, New Taipei (TW)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 13/895,372

(22) Filed: May 16, 2013

(30) Foreign Application Priority Data
May 31, 2012 (CN) 2012101762198

(51) Int. Cl. F21V 21/088; F21V 29/00

(52) U.S. Cl. CPC F21V 21/088; F21V 29/2206
USPC 362/382

(57) ABSTRACT

An LED (Light-Emitting Diode) lighting apparatus includes a lamp cover, a circuit board, a lighting window and a fastening cover. The lamp cover includes button holes. The circuit board is fastened at a bottom of the lamp cover. The lighting window covers the circuit board. The fastening cover is fastened to the lamp cover. The circuit board and the lighting window are arranged between the lamp cover and the fastening cover. The fastening cover includes clips inserted in the button holes of the lamp cover, thereby the fastening cover and the lamp cover being assembled.

### BACKGROUND

1. Technical Field

The present disclosure relates to an LED lighting apparatus, and more particularly, to an LED lighting apparatus without exposed screws.

2. Description of Related Art

LEDs (Light-Emitting Diodes) have many advantages, such as high luminosity, low operational voltage, low power consumption, compatibility with integrated circuits, easy driving, long term reliability, and environmental friendliness. Such advantages have promoted the wide use of the LED lamps as a light source. Quantity demands of LED lamps are increased and appearance requirements are also increasingly highly. Typically, LED lamps are assembled by using lots kinds of screws. After fastening the LED lamps, parts of the screws, such as screw caps are exposed at lighting surfaces of LED lamps. Such exposed screws impact extrinsic features of the LED lamps and further impact assembling and disassembling of the LED lamps since the exposed screws are easily influenced by external environmental corrosion.

What is needed, therefore, is an LED lighting apparatus which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an isometric, assembled view of an LED lighting apparatus in accordance with an embodiment of the present disclosure.

FIG. 2 is similar to FIG. 1, but viewed from another aspect.

FIG. 3 is an exploded view of FIG. 1.

FIG. 4 is an enlarged view showing the LED lighting apparatus of FIG. 2, but the LED lighting apparatus is exploded partly.

FIG. 5 shows an enlarged view of a fastening cover of the LED lighting apparatus in FIG. 3.

FIG. 6 shows an enlarged view of a clip of the fastening cover in FIG. 5.

### DETAILED DESCRIPTION OF THE EMBODIMENTS

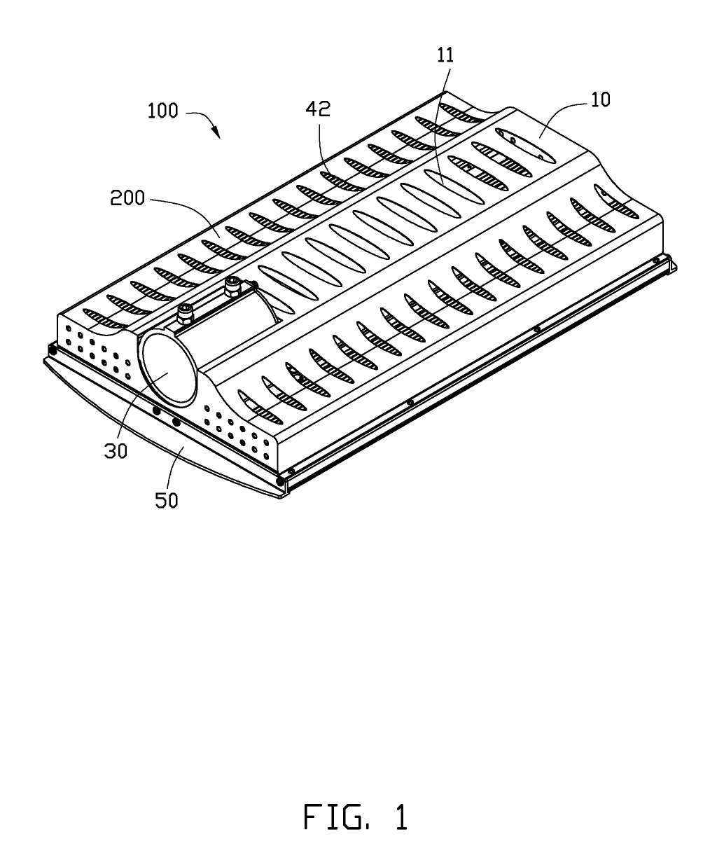

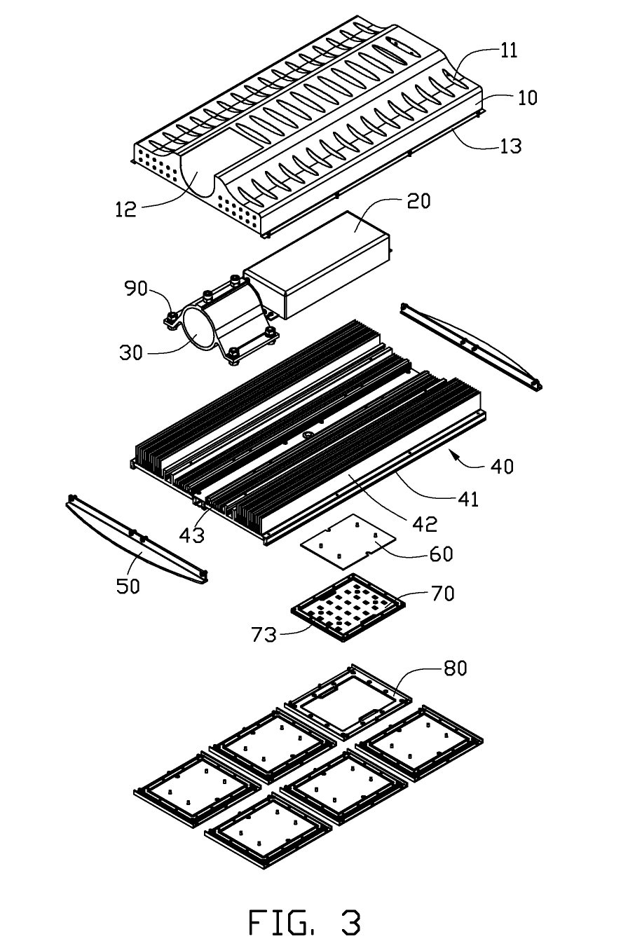

Referring to FIGS. 1-3, an LED (light emitting diode) lighting apparatus 100 in accordance with an embodiment of the present disclosure is shown. A bottom surface (shown in FIG. 1) of the LED lighting apparatus 100 is a light emitting surface. In the following description, all directions, such as top, bottom, front, back, left or right are all according to direction shown in FIG. 1.

The LED lighting apparatus 100 includes a lamp cover 200, a circuit board 60 fastened at a bottom of the lamp cover 200, a lighting window 70 covering the circuit board 60, a fastening cover 80 fixed to the lamp cover 200 and fastening the circuit board 60 and the lighting window 70 to the lamp cover 200, and some screws 90. The lamp cover 200 includes a top cover 10, a drive module 20, a carriage 30, a heat dissipating module 40, two side covers 50 and some screws 90. The top cover 10 covers a top of the heat dissipating module 40. The top cover 10 and the heat dissipating module 40 together form a containing room to contain the drive module 20 and some portions of carriage 30. The carriage 30 is fastened onto a top surface of the heat dissipating module 40 and partly exposed outside the top cover 20. The circuit board 60, the lighting window 70 and the fastening cover 80 are secured on a bottom surface of the heat dissipating module 40.

The top cover 10 is a rectangular-shape cover which has a middle portion higher than a left side and a right side portions. The top cover 10 has a plurality of through holes 11 defined in a top surface thereof and extending along a direction from left to right (shown in FIG. 1). The plurality of through holes 11 are defined in three rows. A middle row of the plurality of through holes 11 is a little bigger than two side rows. A plurality of orifices 14 are also defined in front and rear ends of the top cover 10. An opening 12 is defined at the middle portion and near a front end of the top cover 10. The carriage 30 is exposed from the opening 12 when the LED lighting apparatus 100 is assembled. The carriage 30 works as a connector of the LED lighting apparatus 100 to a steadying bar (not shown). Thus, the LED lighting apparatus 100 can be used as a road lamp. Two fastening flanges 13 are respectively extending from a left side and a right side of the top cover 10. The top cover 10 and the heat dissipating module 40 are assembled by the two fastening flanges 13 being fastened at the heat dissipating module 40.

The heat dissipating module 40 includes two substrates 41, a plurality of first fins 42 and a plurality of second fins 43. Both the first fins 42 and the second fins 43 are extending upwardly form the two substrates 41 arranged side by side. It is understood that the two substrates 41 can be an integrated one. The substrates 41 are connected together by mechanical connections. The flanges 13 of the top cover 10 is fastened at a left side and a right side of the two combined substrates 41 when the top cover 10 and the heat dissipating module 40 are assembled. The plurality of first fins 42 are set on a left portion and a right portion of the two combined substrates 41. The plurality of second fins 43 are set on a middle portion of the two combined substrates 41 which are corresponding to the middle portion of the top cover 10. A height of the first fins 42 is larger than a height of the second fins 43. Thus, the distances between top ends of the first fins 42 and the two side rows of the through holes 11 are smaller than that between top ends of the second fins 43 and the middle row of the through holes 11. The second fins 43 and the middle portion of the top cover 10 together form the containing room to contain the drive module 20 and some portions of carriage 30.

Each side cover 50 includes a horizontal portion and a perpendicular portion. The perpendicular potions of the side covers 50 are fastened at a front and a rear of the heat dissipating module 40. The horizontal portion of the side covers 50 are in a horizontal surface which is a little lower than the substrates 41.

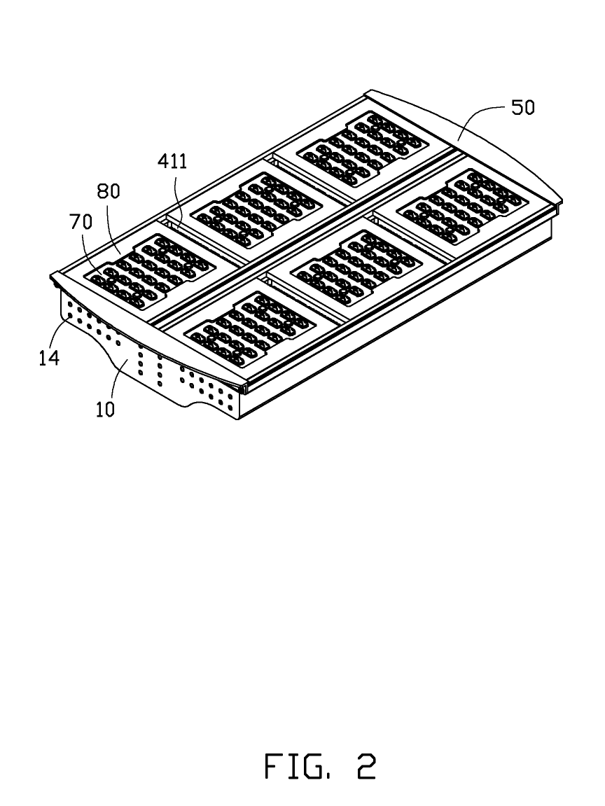

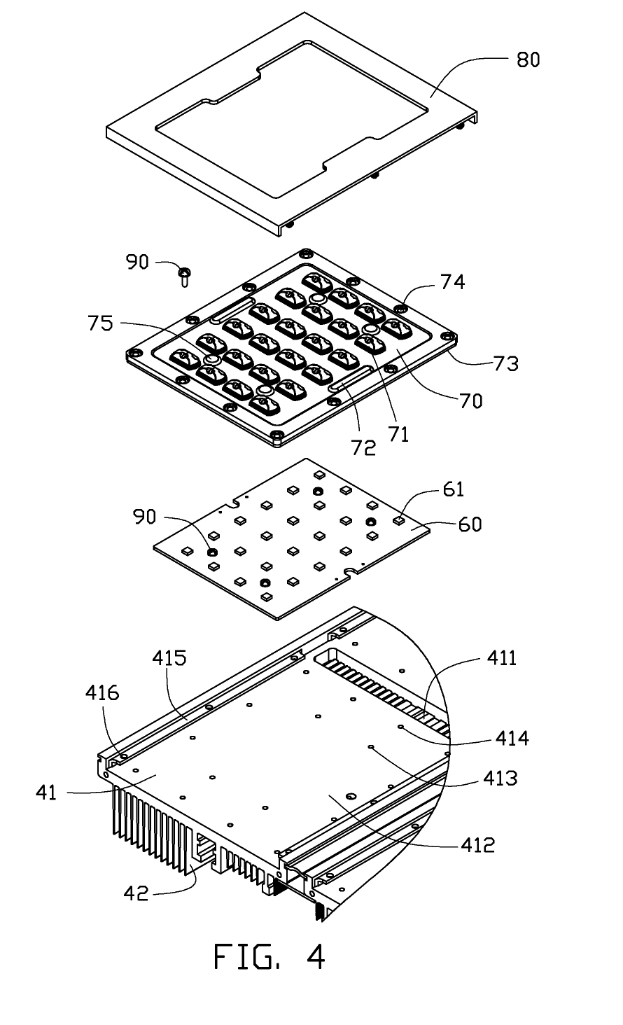

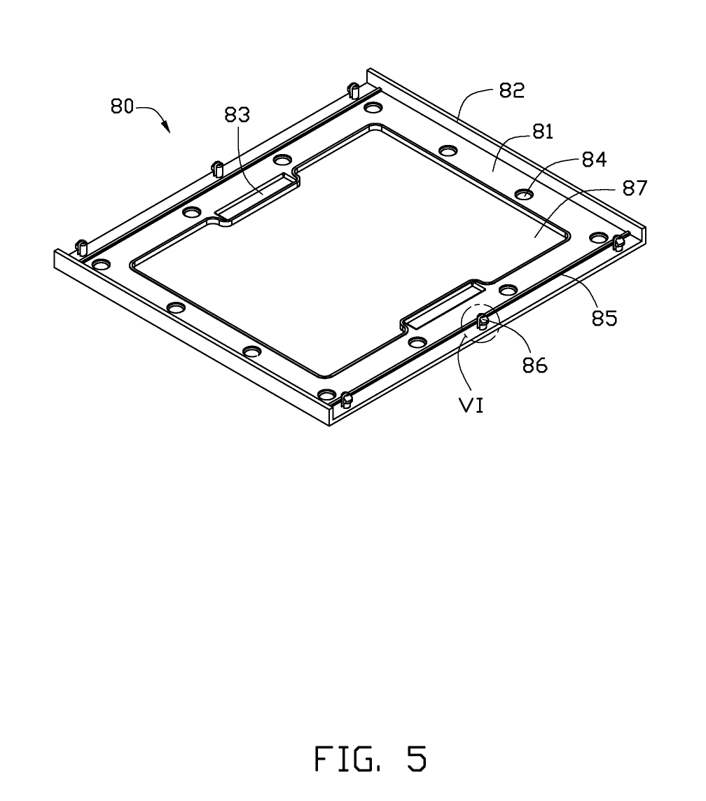

Also referring to FIGS. 4-5, in this embodiment, the LED lighting apparatus 100 includes six circuit boards 60, six lighting windows 70 and six fastening covers 80 corresponding to the six circuit boards 60. The two substrates 41 of the heat dissipating module 40 also define grooves 411 to expose bottom ends the first fins 42 and the second fins 43. The through holes 11 and the orifices 14 defined in the top cover 10 and the grooves 411 defined in the substrates 41 are configured to be a ventilation system and ensure a sufficiently air movement through the top cover 10, the first and second fins 43 to the substrates 41 or reversion. The two combined substrates 41 are divided into at least two fastening areas 412 by the groove 411. In this embodiment, the two substrates 41 totally include four grooves 411 (two in each substrate 41, and clearly shown in FIG. 2) to divide the two substrates 41 into six fastening areas 412 corresponding to the six circuit boards 60. The circuit boards 60, the lighting windows 70 and the fastening covers 80 are arranged in corresponding fastening areas 412 and expose the grooves 411 at the light emitting surface of the LED lighting apparatus 100. It is understood that the LED lighting apparatus 100 can include more than or less than six circuit boards 60. Then, a quantity of the circuit boards 60, the lighting windows 70, the fastening covers 80 and the fastening areas 412 of the substrates 41 is changeable as needed.

Two fastening edges 415 extend from a left side and a right side of each fastening area 412. Each of the fastening edge 415 perpendicularly downwardly extends from the substrates 41 and then horizontally inwardly extends to the corresponding fastening area 412. Three button holes 416 used to combine with the fastening covers 80 are defined at the horizontal portion of each fastening edge 415. The horizontal portion of each fastening edge 415 is separated from the corresponding substrate 41 to provide a space for mounting the corresponding circuit board 60 and lighting window 70. A plurality of screw holes 413 used to fasten the circuit boards 60 are defined at each of the fastening areas 412. A plurality of position holes 414 used to fasten the lighting windows 70 are defined at each of the fastening areas 412.

The circuit boards 60, the lighting windows 70 and the fastening covers 80 are in turn fastened at the fastening areas 412. The circuit boards 60 are fastened at the fastening areas 412 by screws 90 through the screw holes 413 of the substrates 41. A plurality of LEDs 61 which are lighting downwardly are set on a bottom surface of the circuit boards 60. The lighting windows 70 are made of transparent materials. The lighting windows 70 include a plurality of lenses 71 corresponding to the LEDs 61. The lenses 71 contain the LEDs 61 when the lighting windows 70 and the circuit boards 60 are assembled. Each of the lighting windows 70 includes two first position-limiting portions 72 which are used to match positions of the corresponding fastening cover 80. Each of the lighting windows 70 further includes convex portions 75 corresponding to the screws 90 which fix the corresponding circuit boards 60 to the fastening areas 412. The convex portions 75 contain the screws 90 when the lighting window 70 and the corresponding circuit board 60 are assembled.

The LED lighting apparatus 100 further includes rubber bands 73 which have an inner size larger than an outer circle of the circuit boards 60, and have an outer size smaller than or equal to an outer size of the lighting windows 70. The rubber bands 73 are respectively clipped between the lighting windows 70 and the substrates 41 resulting in the circuit boards 60 are hermetically contained between the lighting windows 70 and the substrates 41. Thus, the circuit boards 60 are prevented from humid environment. A plurality of fastening portions 74 are define at the rubber band 73 and the lighting windows 70. The lighting windows 70 and the heat dissipating module 40 are assembled by screws 90 through the fastening portions 74 of the lighting windows 70 and the rubber bands 73 to the position holes 414 of the substrates 41. Thereby the circuit boards 60 are further fastened at the heat dissipating module 40.

It is preferred that the fastening covers 80 are made of plastic material with light weight. Each fastening cover 80 includes a main body 81. The main body 81 is a frame which has an opening 87 configured therein. The opening 87 has a size large enough to expose all lenses 71 of the lighting window 70 therethrough. Two side flanges 82 are extending from a front edge and a rear edge of the main body 81. The two side flanges 82 of the fastening cover 80 and the two fastening edges 415 of the substrate 41 together form a containing room to contain the circuit board 60 and the lighting window 70, when the fastening cover 80 and the heat dissipating module 40 are assembled. The main body 81 includes two second position-limiting portions 83 corresponding to the two first position-limiting portions 72 of the lighting window 70. A plurality of fastening concaves 84 are defined at the main body 81 which are corresponding to the fastening portions 74 of the lighting windows 70. The fastening concaves 84 can cover the screws 90 therefore, the screws 90 will not be exposed outside and can be protected from environmental corrosion. Two convex edges 85 are extending from the main body 81 adjacent to and parallel a left and a right side of the main body 81. A plurality of clips 86 are protruding from the main body 81. The clips 86 each are protruding between the convex edges 85 and the left/right side of the main body 81. The clips 86 are corresponding to the button holes 416 of the substrates 41.

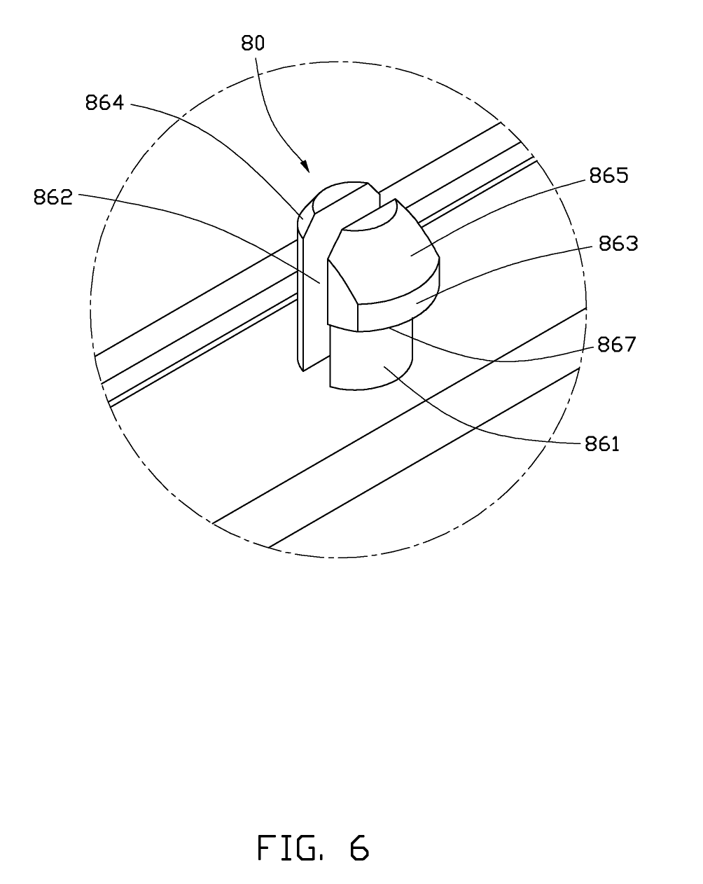

Referring to FIG. 6, each clip 86 includes a first cylinder 861 and a second cylinder 862 separated from the first cylinder 861. Cross sections of the first cylinder 861 and the second cylinder 862 are both semicircle. The first cylinder 861 includes a vertical surface and the second cylinder 862 includes another vertical surface. The two vertical surfaces are face to face. A bump 863 is protruding away from the second cylinder 862 at a top end of the first cylinder 861. The bump 863 has a larger cross section than the first cylinder 861. The bump 863 includes a first inclined surface 865 facing off the main body 81 and a second inclined surface 867 facing to the main body 81. The first inclined surface 865 is inclined backwardly from the second cylinder 862 and downwardly from the top end of the first cylinder 861. The second inclined surface 867 is inclined with a reverse direction of the first inclined surface 865. Thus, the first inclined surface 865 and the second inclined surface 867 form a cusp shape on the top end of the first cylinder 861. The second cylinder 862 includes a third inclined surface 864 which is inclined backwardly from the first cylinder 861 and downwardly from a top end of the second cylinder 862. An angle between the first inclined surface 865 and the vertical surface of the first cylinder 861 is smaller than an angle between the third inclined surface 864 and the vertical surface of the second cylinder 862. A top diameter of a cross-section of the first cylinder 861 and the second cylinder 862 is larger than an end diameter of a cross-section of the first cylinder 861 and the second cylinder 862. Thus, the fastening covers 80 can be steadily assembled to the heat dissipating module 40 when the clips 86 are clipped in the button holes 416.

When assembling the LED lighting apparatus 100, the drive module 20 and the carriage 30 are firstly fastened at the top of the heat dissipating module 40. The top cover 10 then covers the top of the heat dissipating module 40 and exposes some part of the carriage 30. Secondly, the circuit boards 60 and the lighting windows 70 are in turn fastened at the bottom surface of the heat dissipating module 40. Finally, the fastening covers 80 are fastened to the heat dissipating module 40.

Due to the clips 86, the fastening covers 80 can be fastened with no screws 90, and assembly and disassembly of the LED lighting apparatus 100 is convenient. Also due to the fastening covers 80, the screws 90 used to fasten the circuit boards 60 and the lighting windows 70 are prevented from being exposed outside, a uniform extrinsic features of the LED lighting apparatus 100 is obtained and removable function of the screws 90 is constantly maintained.

It is understood that, locking components of the circuit boards 60, the lighting windows 70 and the substrates 41 are not limited to screws.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (Light-Emitting Diode) lighting apparatus, comprising:
a lamp cover comprising button holes;
a circuit board fastened at a bottom of the lamp cover;
a lighting window covering the circuit board; and
a fastening cover comprising clips which is inserted in the button holes of the lamp cover to fasten the fastening cover to the lamp cover, the circuit board and the lighting window arranged between the lamp cover and the fastening cover.

2. The LED lighting apparatus of claim 1, wherein the lamp cover comprises:
a heat dissipating module;
a top cover covering a top of the heat dissipating module and forming a containing room together with the heat dissipating module; and
a drive module contained in the containing room.

3. The LED lighting apparatus of claim 2, wherein the heat dissipating module comprises a substrate, a plurality of first fins and a plurality of second fins extending upwardly from the substrate and arranged in parallel.

4. The LED lighting apparatus of claim 3, wherein the plurality of first fins are set on two opposite side portions of the substrate, and the plurality of second fins are set on a middle portion of the substrate.

5. The LED lighting apparatus of claim 4, wherein a height of the first fins is larger than a height of the second fins.

6. The LED lighting apparatus of claim 5, wherein the lamp cover further comprises a carriage fastened thereon, the carriage being partly contained in the containing room between the top cover and the second fins.

7. The LED lighting apparatus of claim 5, wherein the top cover comprises a plurality of through holes arranged in three rows.

8. The LED lighting apparatus of claim 7, wherein a middle row of the plurality of through holes are bigger than two side rows of the plurality of through holes.

9. The LED lighting apparatus of claim 7, wherein distances between top ends of the first fins and the top cover are smaller than that between top ends of the second fins and the top cover.

10. The LED lighting apparatus of claim 6, wherein an opening is defined at the middle portion and near a front of the top cover, and the carriage is exposed from the opening.

11. The LED lighting apparatus of claim 2, wherein two fastening flanges are respectively extending from two opposite edges of the top cover, and the top cover and the heat dissipating module are assembled by the two fastening flanges fastened at the heat dissipating module.

12. The LED lighting apparatus of claim 3, wherein the substrate of the heat dissipating module further comprises grooves exposing bottom ends the first fins and the second fins.

13. The LED lighting apparatus of claim 12, wherein the substrate is divided into at least two fastening areas by the groove.

14. The LED lighting apparatus of claim 13, wherein two fastening edges are respectively extending from two opposite sides of each fastening area, each of the fastening edge perpendicularly downwardly extends from the substrate and then horizontally inwardly extends to a corresponding fastening area.

15. The LED lighting apparatus of claim 14, wherein the button holes used to combine with the fastening covers are defined at the horizontal portion of each fastening edge.

16. The LED lighting apparatus of claim 1, wherein the clips of the fastening cover comprises a first cylinder and a second cylinder away from the first cylinder, and a bump is protruding a top end of the first cylinder along a direction away from the second cylinder.

17. The LED lighting apparatus of claim 16, wherein the bump has a larger cross section than the first cylinder.

18. The LED lighting apparatus of claim 17, wherein the bump comprises a first inclined surface facing off the main body and a second inclined surface facing to the main body, the first inclined surface is inclined backwardly from the second cylinder and downwardly from the top end of the first cylinder, and the second inclined surface is inclined with a reverse direction of the first inclined surface.

19. The LED lighting apparatus of claim 1, wherein the lighting window comprises two first position-limiting portions, and the fastening cover comprises two second position-limiting portions matching with the two first position-limiting portions of the lighting window.
